(19) United States
(12) Patent Application Publication
(10) Pub. No.: US 2004/0155623 A1
(43) Pub. Date: Aug. 12, 2004

(54) Motor power supply

(75) Inventor: Jang-Hyoun Youm, Suwon city (KR)

Correspondence Address: STAAS & HALSEY LLP, SUITE 700, 1201 NEW YORK AVENUE, N.W., WASHINGTON, DC, 20005, US

(73) Assignee: Samsung Electronics, Suwon City (KR)

(21) Appl. No.: 10/704,610

(22) Filed: Nov. 12, 2003

(30) Foreign Application Priority Data
Feb. 12, 2003 (KR) 2003-8883

(51) Int. Cl. H02P 5/34

(52) U.S. Cl. 318/801

(57) ABSTRACT

A motor power supply including a DC power supply having a pair of power output terminals, and an inverter having a pair of connection terminals connected to the power output terminals of the DC power supply through a pair of power lines, converting power from the DC power supply to supply the converted power to a motor having a plurality of power input terminals, the motor power supply including a braking resistor provided in an additional line connecting the connection terminals with each other; a switching part provided at one of the connection terminals, and selectively connecting the one of the connection terminals with the power output terminal corresponding to the one of the connection terminals, or with the additional line; and a controller controlling the switching part. Components common to both a dynamic braking circuit and the inverter decrease the total size and cost of the motor supply power.

### CROSS-REFERENCE TO RELATED APPLICATIONS

This application claims the benefit of Korean Patent Application No. 2003-8883, filed Feb. 12, 2003, in the Korean Intellectual Property Office, the disclosure of which is incorporated herein by reference.

### BACKGROUND OF THE INVENTION

1. Field of the Invention

The present invention relates to a power supply for a motor, which comprises a DC (direct current) power supply having a pair of power output terminals, and an inverter having a pair of connection terminals connected to the power output terminals of the DC power supply through a pair of power lines, and converting power from the DC power supply to supply the converted power to a motor having a plurality of power input terminals, and, more particularly, to a motor power supply in which certain components are common to both a dynamic braking circuit and an inverter, thereby decreasing the total size of the motor power supply and the production cost.

2. Description of the Related Art

A three-phase motor has three windings and is driven by three-phase power. As shown in FIG. 1, a motor power supply for the three-phase motor includes an AC (alternating current) power supply 120 supplying commercial AC power (110V/220V), a diode rectifier 130 rectifying the AC power from the AC power supply 120 into DC power, a capacitor 140 smoothing the rectified power from the diode rectifier 130, an inverter 150 converting the DC power from the capacitor 140 into AC power having three phases and various frequencies, and a dynamic braking circuit 170 short-circuiting the power input terminals 112 of a motor 110. Generally, the conventional motor power supply further includes a soft charging circuit (not shown) to protect the capacitor 140 from a surge current occurring when initial power is supplied, a PFC (power factor correction) circuit (not shown) to keep the output voltage of the capacitor 140 constant, and an over voltage protection circuit (not shown) to protect the capacitor 140 from over voltage.

The inverter 150 includes a PWM (pulse width modulation) part (not shown) to generate a square wave signal for PWM, and a plurality of transistors 154b that are turned on/off in response to the square wave signal of the PWM part. Further, the motor power supply includes a controller (not shown) turning on/off the transistors 154b of the inverter 150 in response to the square wave signal of the PWM part, and modulating power frequency to control the rotation speed of the motor 110.

The inverter 150 includes three inverting circuits 152, which are respectively connected to the capacitor 140 in parallel. Each inverting circuit 152 includes a pair of inverting elements 154, wherein each inverting element 154 includes a transistor 154b and a diode 154a that are connected in parallel. The power input terminals 112 of the motor 110 are respectively connected to lines connecting the inverting elements 154 of each inverting circuit 152 so that motor 110 receives the three-phase power from the inverter 150.

The dynamic braking circuit 170 includes three pairs of dynamic braking diodes 176. Each of the power input terminals 112 of the motor 110 is respectively connected to a line connecting a pair of dynamic braking diodes 176 which are aligned in one direction. Each pair of dynamic braking diodes 176 aligned in one direction is connected to a resistor 172 and a relay 174 in parallel. The dynamic braking circuit 170 brings the motor 110 to a sudden stop and prevents the motor 110 from free rotation due to an external force after the motor 110 is stopped. When the motor 110 normally rotates, the relay 174 is open. When the motor 110 stops rotating or after the motor 110 is suddenly stopped, the relay 174 is closed. When the dynamic braking circuit closes the relay 174, the motor 110 is suddenly stopped. When the relay 174 is closed the motor 110 is prevented from free rotation due to the external force.

However, because the conventional dynamic braking circuit 170 operates only when AC power is not applied and when the motor is rotating, the conventional dynamic braking circuit 170 is not needed when power is being supplied and the capacitor 140 is being charged with the power, that is, when the motor 110 is rotating normally.

Further, the conventional dynamic braking circuit 170 generally uses a resistor having a large resistance or a thermistor as the resistor 172 for preventing the motor 110 from being damaged due to a large electric current flowing when the motor 110 is forcibly rotated by an external force.

Thus, not only the size of the motor power supply is increased because the dynamic braking circuit is taken into consideration for circuit design, but also the total number of components is increased due to, for example, the dynamic braking diodes 176, the relay 174 (e.g., a 1-point relay having a large capacity) etc. Therefore, the whole size of the motor power supply and the production cost are increased.

### SUMMARY OF THE INVENTION

It is an aspect of the present invention to provide a motor power supply in which some elements are common to both a dynamic braking circuit and an inverter, thereby decreasing the whole size of the motor power supply and the production cost.

Additional aspects and advantages of the invention will be set forth in part in the description which follows and, in part, will be obvious form the description, or may be learned by practice of the invention.

To achieve the above and/or other aspects of the present invention, there is provided a motor power supply including a DC power supply having a pair of power output terminals, and an inverter having a pair of connection terminals connected to the power output terminals of the DC power supply through a pair of power lines, and converting power from the DC power supply to supply the converted power to a motor having a plurality of power input terminals, the motor power supply including a braking resistor provided in an additional line connecting the connection terminals with each other, a switching part provided at one of the connection terminals, and selectively connecting the one of the connection terminals with the power output terminal corresponding to the one of the connection terminals, or with the additional line, and a controller controlling the switching part.

The DC power supply includes an AC power supply, a rectifying part rectifying power supplied from the AC power supply, and a capacitor smoothing the rectified power from the rectifying part.

The inverter includes a plurality of inverting circuits respectively connected to the capacitor in parallel, each inverting circuit having inverting members comprising a transistor and a diode that are connected in parallel, and the power input terminals of the motor are respectively connected between the inverting members of each inverting circuit.

The switching part is, for example, a 2-point relay with a first contact point to connect the braking resistor with each inverting circuit in parallel, and a second contact point to connect the capacitor with each inverting circuit in parallel.

The controller controls the 2-point relay to contact the first contact point, turning off the transistor of each inverting member.

The controller controls the 2-point relay to contact the second contact point while the motor is rotating, and controls the 2-point relay to contact the first contact point when the motor is braked.

To achieve the above and/or other aspects according to the present invention, there is provided a braking circuit for a motor having a plurality of power input terminals, including a DC power supply with a first terminal and a second terminal; an inverter with a first terminal and a second terminal, and being connected to the power input terminals of the motor; a switch at the first terminal of the inverter, the switch having a first contact point and a second contact point, the second contact point connected to the first terminal of the DC power supply; a braking resistor connected between the first contact point and the second terminal of the inverter, the second terminal of the DC power supply being connected to the second terminal of the inverter; and a controller controlling the switch.

To achieve the above and/or other aspects according to the present invention, there is provided a DC power supply having a pair of power output terminals, the DC power supply having an AC power supply, a rectifying part rectifying power supplied from the AC power supply, and a capacitor smoothing the rectified power from the rectifying part; an inverter having a pair of connection terminals connected to the power output terminals of the DC power supply through a pair of power lines, and converting power from the DC power supply to supply the converted power to the motor, the inverter including a plurality of inverting circuits respectively connected to the capacitor in parallel, each inverting circuit having inverting members with a transistor and a diode that are connected in parallel, and the power input terminals of the motor being respectively connected between the inverting members of each inverting circuit; a braking resistor provided in an additional line connecting the connection terminals with each other; a switching part provided at one of the connection terminals, and selectively connecting the one of the connection terminals with the power output terminal corresponding to the one of the connection terminals, or with the additional line, wherein the braking resistor, the switching part, and the diodes form a dynamic braking circuit to bring the motor to a sudden stop, preventing the motor from freely rotating due to an external force, and the diodes are commonly used by the dynamic braking circuit and the inverter to reduce a size and cost of the motor power supply.

These, together with other aspects and/or advantages that will be subsequently apparent, reside in the details of construction and operation as more fully hereinafter described and claimed, reference being had to the accompanying drawings forming a part thereof, wherein like numerals refer to like parts throughout.

### BRIEF DESCRIPTION OF THE DRAWINGS

These and/or other aspects and advantages of the present invention will become apparent and more readily appreciated from the following description of the embodiments, taken in conjunction with the accompany drawings, of which:

FIG. 1 is a circuit diagram of a conventional motor power supply;

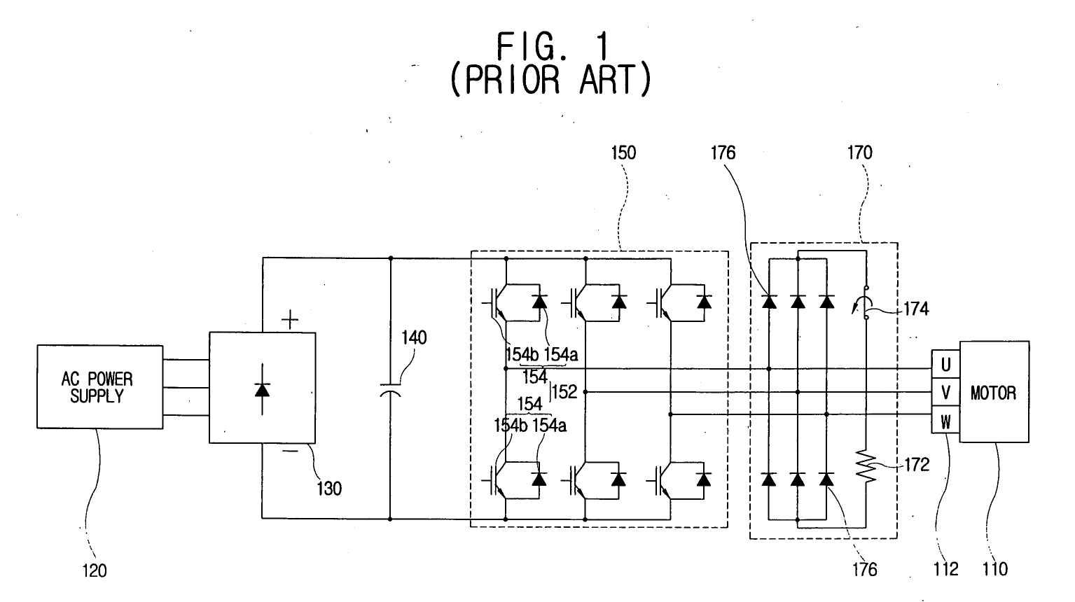

FIG. 2 is a circuit diagram of a motor power supply according to an embodiment of the present invention;

FIG. 3A is a circuit diagram of the motor power supply according to the present invention while a motor is being rotated; and

FIG. 3B is a circuit diagram of the power supply according to the present invention while the motor is braked.

### DESCRIPTION OF THE PREFERRED EMBODIMENT

Hereinafter, an embodiment of the present invention will be described in detail with reference to the attached drawings, wherein the like reference numerals refer to the like elements throughout. The present invention may, however, be embodied in many different forms and should not be construed as being limited to the embodiment set forth herein; rather, this embodiment is provided so that the present disclosure will be thorough and complete, and will fully convey the concept of the invention to those skilled in the art.

Hereinafter, a power supply for a three-phase motor will be exemplarily described.

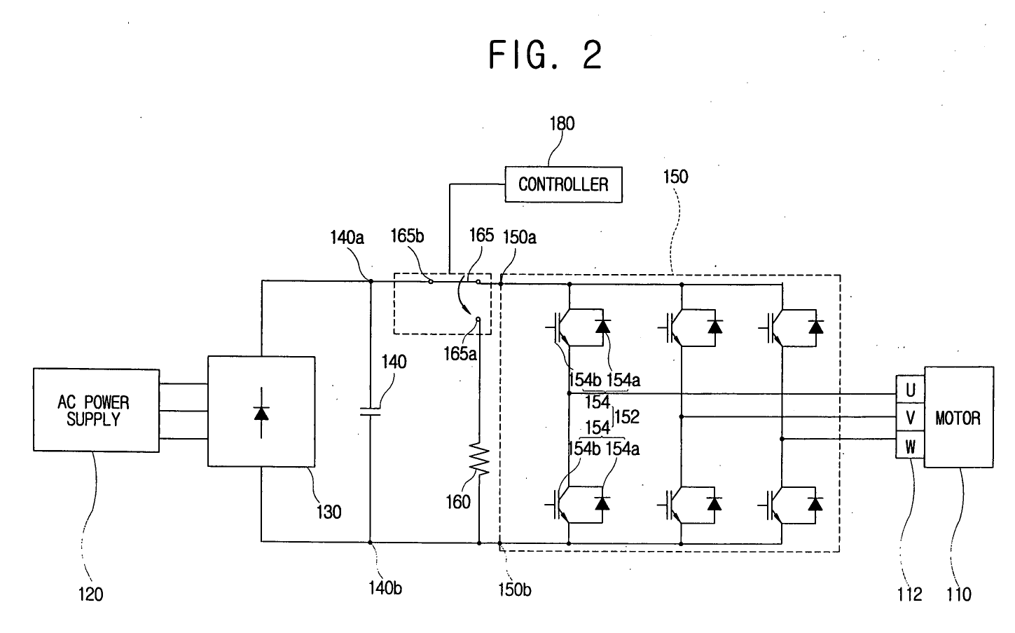

FIG. 2 is a circuit diagram of a motor power supply according to an embodiment of the present invention. As shown in FIG. 2, a motor power supply includes an AC power supply 120 supplying commercial AC power (110V/220V), a diode rectifier 130 rectifying the AC power from the AC power supply 120 into DC power, a capacitor 140 smoothing the rectified power from the diode rectifier 130, and an inverter 150 converting the DC power from the capacitor 140 into AC power having three phases and various frequencies.

Further, the motor power supply according to the present invention includes a braking resistor 160 having a first end connected to a line connecting a first terminal 140b of the capacitor 140 with a first terminal 150b of the inverter 150; a switching part 165 corrected to a second terminal 150a of the inverter 150, and having a first contact point 165a connected to a second end of the braking resistor 160 and a second contact point 165b connected to a second terminal 140a of the capacitor 140; and a controller 180 controlling the switching part 165 to contact the second contact point 165b to supply three-phase power to a motor 110 or to contact the first contact point 165a to allow the braking resistor 160 and the inverter 150 to perform a dynamic braking operation.

The inverter 150 includes three inverting circuits 152, which are respectively connected to the capacitor 140 in parallel. Each inverting circuit 152 includes a pair of inverting elements 154, wherein each inverting element 154 includes a transistor 154b and a diode 154a that are connected in parallel. The power input terminals 112 of the motor 110 are respectively connected between the inverting elements 154 of each inverting circuit 152 so that the motor 110 receives three-phase power from the inverter 150.

The switching part 165 is a 2-point relay, for example, which has the first contact point 165a to connect the braking resistor 160 with all inverting circuits 152 in parallel, and the second contact point 165b to connect the capacitor 140 with all inverting circuits 152 in parallel.

The controller 180 controls the switching part 165 to contact the second contact point 165b while the motor 110 is rotating, thereby supplying three-phase power to the motor 110. Further, the controller 180 controls the switching part 165 to contact the first contact point 165a while the motor 110 is braked, thereby allowing the braking resistor 160 and the inverter 150 to perform dynamic braking.

According to the present invention, the switching part 165, the diodes 154a, and the braking resistor 160 operate as a dynamic braking circuit. That is, when the switching part 165 contacts the first contact point 165a, each of the power input terminals 112 of the motor 110 is respectively connected to a line connecting one of the pairs of inverting elements 154. The dynamic braking diodes 154a are aligned in one direction and connected to the braking resistor 160 in parallel. Thus, when the switching part 165 is in contact with the first contact point 165a, the switching part 165, the diodes 154a, and the braking resistor 160 operate as the dynamic braking circuit to bring the motor 110 to a sudden stop and prevent the motor 110 from free rotation due to an external force after the motor 110 stops. Additionally, when the switching part 165 is in contact with the first contact point 165a, a large electric current flowing when the motor 110 is forcibly rotated by an external force is offset by the resistance of the braking resistor 160 to prevent the motor 110 from being damaged.

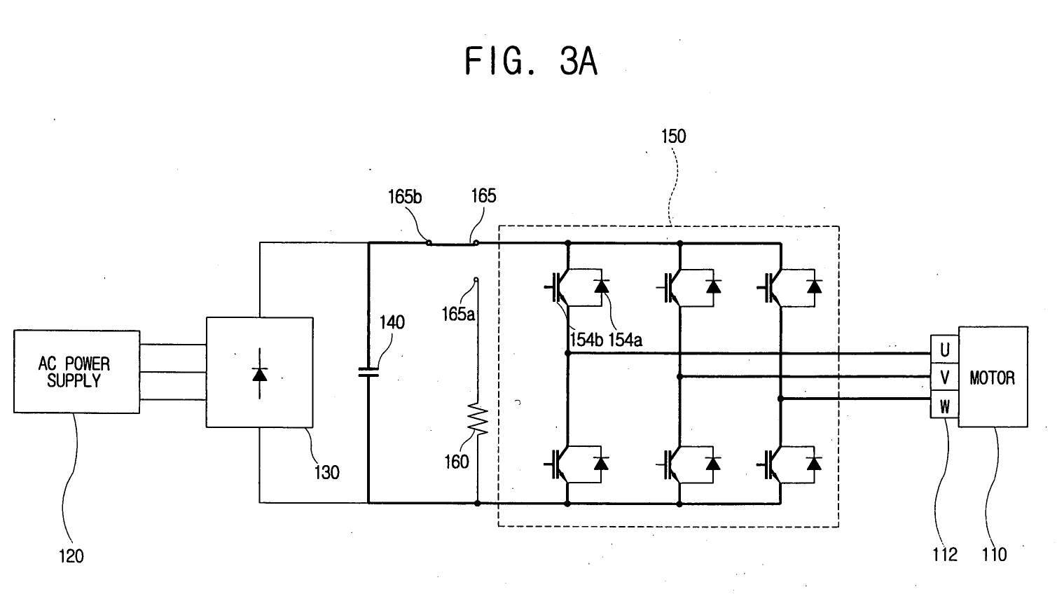

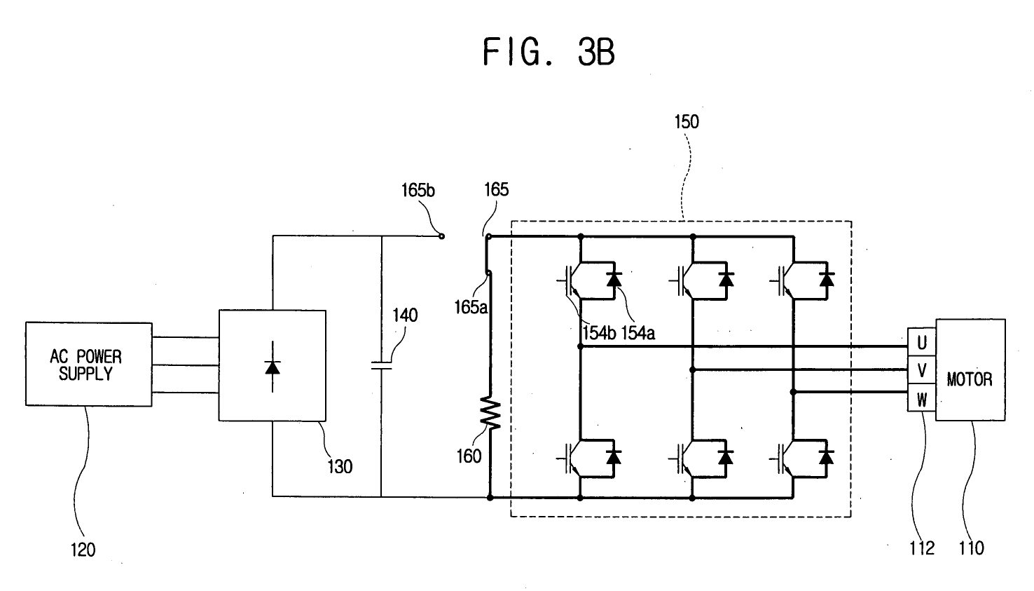

Operation of the motor power supply according to the present invention is described below with reference to FIGS. 3A and 3B.

Referring to FIG. 3A, first, AC power is supplied from the AC power supply 120 and rectified by the diode rectifier 130. Then, the capacitor 140 is charged with the rectified power. After the capacitor 140 is completely charged with the rectified power, if a motor driving signal is generated externally, the switching part 165 contacts the second contact point 165b. Then, the DC power charged in the capacitor 140 is supplied to the inverter 150, and the inverter 150 converts the DC power into three-phase AC power, thereby supplying the three-phase AC power to the motor 110 and rotating the motor 110.

Referring to FIG. 3B, if the motor 110 is braked, the switching part 165 contacts the first contact point 165a, thereby turning off the transistors 154b of the inverter 150. The braking resistor 160, the switching part 165, and the diodes 154a of the inverter 150 operate as the dynamic braking circuit and short-circuit the power input terminals 112 of the motor 110 to bring the motor 110 to a sudden stop.

When power is not supplied to the motor 110, the switching part 165 contacts the first contact point 165a, thereby preventing the motor 110 from freely rotating due to application of an external force. Further, a large electric current flowing when the motor 110 is forcibly rotated by the external force is offset by the resistance of the braking resistor 160 to prevent the motor 110 from being damaged.

Consequently, the diodes 154a are used in both the inverter 150 and the dynamic braking circuit so that the total number of components is reduced, thereby decreasing the total size of the motor power supply and the production cost.

As described above, the present invention provides a motor power supply in which certain components are common to both a dynamic braking circuit and an inverter, thereby decreasing the total size of the motor power supply and the production cost.

Although an embodiment of the present invention has been shown and described, it will be appreciated by those skilled in the art that changes may be made in this embodiment without departing from the principles and spirit of the invention, the scope of which is defined in the appended claims and their equivalents.

What is claimed is:

1. A motor power supply comprising a DC power supply having a pair of power output terminals, and an inverter having a pair of connection terminals connected to the power output terminals of the DC power supply through a pair of power lines, and converting power from the DC power supply to supply the converted power to a motor having a plurality of power input terminals, the motor power supply comprising:
a braking resistor provided in an additional line connecting the connection terminals with each other;
a switching part provided at one of the connection terminals, and selectively connecting the one of the connection terminals with the power output terminal corresponding to the one of the connection terminals, or with the additional line; and
a controller controlling the switching part.

2. The motor power supply according to claim 1, wherein the DC power supply comprises an AC power supply, a rectifying part rectifying power supplied from the AC power supply, and a capacitor smoothing the rectified power from the rectifying part.

3. The motor power supply according to claim 2, wherein
the inverter comprises a plurality of inverting circuits respectively connected to the capacitor in parallel, each inverting circuit having inverting members comprising a transistor and a diode that are connected in parallel, and
the power input terminals of the motor are respectively connected between the inverting members of each inverting circuit.

4. The motor power supply according to claim 2, wherein the switching part is a 2-point relay with a first contact point to connect the braking resistor with each inverting circuit in parallel, and a second contact point to connect the capacitor with each inverting circuit in parallel.

5. The motor power supply according to claim 4, wherein the controller controls the 2-point relay to selectively contact the first contact point, turning off the transistor of each inverting member.

6. The motor power supply according to claim 4, wherein the controller controls the 2-point relay to selectively contact the second contact point while the motor is rotating, and controls the 2-point relay to contact the first contact point when the motor is braked.

7. The motor power supply according to claim 3, wherein the braking resistor, the switching part, and the diodes form a dynamic braking circuit to bring the motor to a sudden stop, preventing the motor from freely rotating due to an external force.

8. The motor power supply according to claim 7, wherein the diodes are commonly used by the dynamic braking circuit and the inverter to reduce a size and cost of the motor power supply.

9. The motor power supply according to claim 3, wherein all the diodes are aligned in one direction and connected to the braking resistor in parallel.

10. The motor power supply according to claim 4, wherein when the switching part contacts the first contact point, a large current flowing when the motor is forcibly rotated by an external force is offset by a resistance of the braking resistor to prevent damage to the motor.

11. A braking circuit for a motor having a plurality of power input terminals, comprising:
a DC power supply with a first terminal and a second terminal;
an inverter with a first terminal and a second terminal, and being connected to the power input terminals of the motor;
a switch at the first terminal of the inverter, the switch having a first contact point and a second contact point, the second contact point connected to the first terminal of the DC power supply;
a braking resistor connected between the first contact point and the second terminal of the inverter, the second terminal of the DC power supply being connected to the second terminal of the inverter; and
a controller controlling the switch.

12. The braking circuit of claim 11, wherein the DC power supply comprises:
an AC power supply supplying AC power;
a rectifier connected to the AC power supply and rectifying the AC power to provide DC power;
a capacitor connected to the rectifier and being charged with the DC power.

13. The braking circuit of claim 12, wherein when the switch contacts the second contact point, the DC power charged in the capacitor is supplied to the inverter, and the inverter converts the DC power into three-phase AC power to rotate the motor.

14. The braking circuit of claim 13, wherein the inverter comprises a plurality of inverting circuits respectively connected to the capacitor in parallel, each inverting circuit having a pair of connected inverting members with a transistor and a diode connected in parallel, the power input terminals of the motor being connected respectively between the inverting members of each inverting circuit.

15. The braking circuit of claim 14, wherein when the switch contacts the first contact point, each transistor is turned off, short-circuiting the power input terminals of the motor to bring the motor to a stop.

16. The braking circuit of claim 14, wherein the diodes are commonly used by the inverter.

17. A motor power supply for a motor having a plurality of power input terminals, comprising:
a DC power supply having a pair of power output terminals, the DC power supply comprising an AC power supply, a rectifying part rectifying power supplied from the AC power supply, and a capacitor smoothing the rectified power from the rectifying part;
an inverter having a pair of connection terminals connected to the power output terminals of the DC power supply through a pair of power lines, and converting power from the DC power supply to supply the converted power to the motor, the inverter comprising a plurality of inverting circuits respectively connected to the capacitor in parallel, each inverting circuit having inverting members comprising a transistor and a diode that are connected in parallel, and the power input terminals of the motor being respectively connected between the inverting members of each inverting circuit;
a braking resistor provided in an additional line connecting the connection terminals with each other;
a switching part provided at one of the connection terminals, and selectively connecting the one of the connection terminals with the power output terminal corresponding to the one of the connection terminals, or with the additional line, wherein
the braking resistor, the switching part, and the diodes form a dynamic braking circuit to bring the motor to a sudden stop, preventing the motor from freely rotating due to an external force, and
the diodes are commonly used by the dynamic braking circuit and the inverter to reduce a size and cost of the motor power supply.
